(19) United States
(12) Patent Application Publication
(10) Pub. No.: US 2005/0093685 A1
(43) Pub. Date: May 5, 2005

(54) Actuator device and safety mechanism for a motor vehicle

(75) Inventors: Checrallah Kachouh, Dortmund (DE); Peter Bartel, Hattingen (DE)

Correspondence Address: NIXON PEABODY, LLP, 401 9TH STREET, NW, SUITE 900, WASHINGTON, DC, 20004-2128, US

(73) Assignee: Brose Schliesssysteme GmbH & Co. KG, Wuppertal (DE)

(21) Appl. No.: 10/964,834

(22) Filed: Oct. 15, 2004

(30) Foreign Application Priority Data
Oct. 22, 2003 (DE) 103 49 547.9

(51) Int. Cl. H01H 35/00

(52) U.S. Cl. 340/438

(57) ABSTRACT

An actuator device, safety device and an associated method for emergency triggering of a safety mechanism of a motor vehicle. The actuator device includes an actuator and a gear, where the actuator is operable in a triggering direction for triggering the safety mechanism and the actuator device is designed such that a function test for checking operability of the actuator can be performed without triggering the safety mechanism.

### BACKGROUND OF THE INVENTION

1. Field of the Invention

The invention relates to an actuator device and safety mechanism for a motor vehicle. More specifically, the present invention relates to performing a function test with regard to triggering of a safety mechanism of a motor vehicle.

2. Description of the Related Art

German Patent Application DE 100 38 431 A1 discloses a power lock for a motor vehicle safety device. Various safety mechanisms for motor vehicles are known that, in the event of an accident, prevent injury to people involved in the accident, or attempt to restrict the gravity of injuries. For example, roll bars, headrests, knee pads, displaceable engine bonnets, displaceable steering wheels, or the like illustrate some of the safety mechanisms associated with automobiles.

The safety mechanisms are normally brought into their support position mechanically in the event of an accident, where the power or energy required to manoeuvre the mechanisms is made available by mechanical or pneumatic springs. Prior to an accident, the safety mechanisms of power locks are kept in a tensioned functional state, where high forces are maintained. The problem is that this type of power lock is rarely triggered, but triggering of the lock still needs to reliably function in an emergency, in particular, in the event of an accident.

### SUMMARY OF THE INVENTION

An object of the present invention is to provide an actuator device, a safety mechanism for a motor vehicle, and an associated process for checking the operability of an actuator of an actuator device, to ensure secure triggering of the safety mechanism.

A basic aspect of the present invention is to operate or actuate an actuator of the actuator device to check its operability without triggering the safety mechanism. In this way, a check can be made to ensure that the actuator for releasing the safety mechanism actually functions. Accordingly, this increases reliability, and thus, safety in the event of an accident, since an essential functioning of the safety mechanism can be verified.

The actuator of the present invention is preferably operated during a function test counter to the direction of trigger and then is reset to its start position by means of a resilient force. This allows a very simple implementation that provides increased safety and reliability.

The function test is preferably carried out regularly and automatically. If the function test fails, repairs can be immediately made to the actuator device, so that the breakdown probability, in the event of an actual accident, at least is substantially reduced.

Further advantages, characteristics, properties and aspects of the present invention will emerge from the following description of a preferred embodiment with reference to the accompanying drawings.

### BRIEF DESCRIPTION OF THE DRAWINGS

FIG. 1 is a schematic illustration of an actuator device for a safety mechanism of a motor vehicle in accordance with an exemplary embodiment of the present invention; and

FIG. 2 is a schematic illustration of a proposed safety mechanism with an assigned actuator device in accordance with an exemplary embodiment of the present invention.

### DETAILED DESCRIPTION OF THE INVENTION

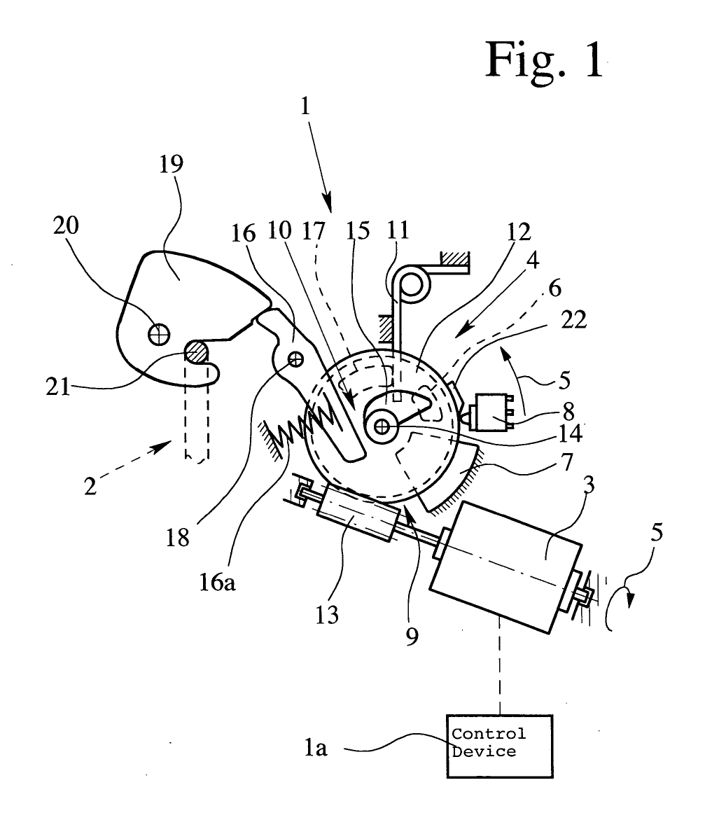

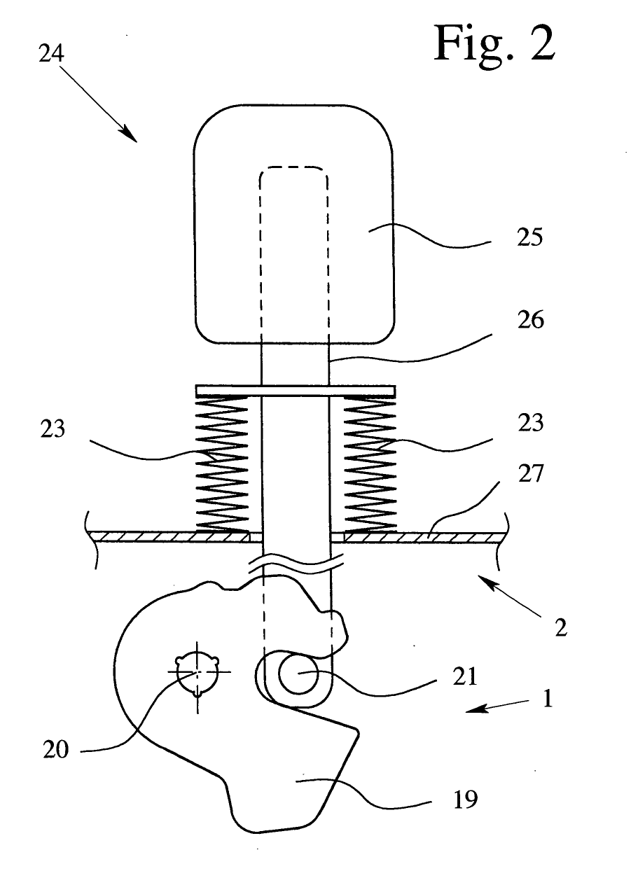

FIG. 1 shows an actuator device 1 for triggering of a safety mechanism 2 of a motor vehicle in accordance the present invention. The safety mechanism 2 is illustrated in FIG. 2. The actuator device 1 is a power lock in accordance with an exemplary embodiment the present invention. When a motor vehicle is involved in an accident, the safety mechanism 2 is triggered. However, there can also be other driving-related situations or emergencies, where the safety mechanism 2 can be triggered.

The safety mechanism 2, in accordance with exemplary embodiments of the invention, can include a displaceable roll bar (FIG. 2), a displaceable headrest (FIG. 2), a displaceable knee pad, a displaceable engine hood, a displaceable steering wheel or the like.

The actuator device 1 includes an actuator 3 and preferably an assigned gear 4. The actuator 3 can be operated or actuated in a triggering direction 5 to trigger the safety mechanism 2. The actuator 3 works preferably electrically and is designed, in particular, as an electromotor. If needed, the electromotor can be a linear drive, linear motor or an electromagnet, but it is preferably a motor generating revolutions.

In accordance with the present invention, during a function test, the actuator 3 is operated or actuated for checking its operability without triggering the safety mechanism 2. The actuator 3 is preferably operated in the function test counter to the triggering direction 5, until stops 6, 7 of the actuator device I limit further movement and/or a sensor device 8 (e.g., a Hall sensor or microswitch) has detected that backwards actuation or movement by the actuator 3 has occurred, and therefore the actuator 3 functions. Then, the actuator 3 and/or the gear 4 is preferably reset to a start position automatically through employment of a resilient force, after the actuator 3 is shut off. The actuator 3 is preferably short-circuited when reset. If needed, a generator current created by the actuator 3 or the short-circuit current can be detected and evaluated with respect to the operability of the actuator 3.

Alternatively or additionally, when the actuator 3 is running during the function test (i.e., when the actuator 3 is switched on) and/or when movement limits have been reached, such as overrunning the stops 6, 7, the actuator current can be detected and evaluated with respect to the operability and/or switching off of the actuator 3.

Also, the actuator 3 can be operated during the function test in the triggering direction 5, insofar as the gear 4 or the release mechanism has sufficient play and/or insofar as the actuator 3 and/or the gear 4 can be decoupled by means of a coupling (not illustrated) so that no unwanted triggering of the safety mechanism 2 occurs during the function test.

The gear 4 preferably has a worm gear pair 9 and/or an eccentric/lever combination 10. The worm gear pair 9 is preferably designed as non-self-locking, including a gear reduction ratio of at most 30:1. Additionally, in accordance with another exemplary embodiment, the gear reduction ratio can also be at most 25:1, as well as 20:1 or less.

A reset spring 11 is assigned to a worm wheel 12, driven by the actuator 3 by means of a worm 13. If required, the reset spring 11 is arranged on the axis 14 of the worm wheel 12 of the worm gear pair 9. This enables a particularly compact construction. If the reset spring 11 is arranged on the axis 14 of the worm wheel 12, relative movement between spring leg and worm wheel 12 is avoided. This increases the smooth running of the mechanics and reduces wear and tear on the actuator device.

In the example illustrated in FIG. 1, the worm wheel 12 has a cam-shaped or spiral shaped drive element 15 for actuating an assigned lever, in particular, a detent pawl 16. Therefore, depending on the rotational position of the worm wheel 11 or when the worm wheel 12 is rotating in the direction of trigger 5, the detent pawl 16 can be opened by the drive element 15 engaging with or coming to engage with the detent pawl 16. A relatively large gear reduction ratio is preferably provided. In particular, the ratio of the gearing down of the rotational movement of the worm wheel 12 for actuating the lever or the pawl 16 is at least 10:1, and preferably 15:1 or more.

When the worm wheel 12 is rotated in the triggering direction 5, a further boss or cam 17, arranged on the worm wheel 12, engages on the stationary, housing-side stop 7 of the actuator device 1, so that the worm wheel 12 is blocked against further rotation in the direction of trigger 5. Thus, the end position or open position of the worm wheel 12 is fixed.

As already mentioned, the end position of the worm wheel 12 is fixed by the stop 6 in the illustrated example. Likewise, running up or stopping on the fixed stop 7 when turning against the direction of trigger 5 in the function test. In the example, the stops 6, 17 additionally form a radial engagement area for the reset spring 11. Here, other constructive solutions are also possible.

When opened, the detent pawl 16 is pivoted clockwise about the axis 18 in the illustrated example. The detent pawl 16 then releases an assigned rotary latch 19, so that the latter can pivot about a bearing axis 20 and can release an actuation element 21 of the safety mechanism 2 held in the locked or detained state. This release causes triggering of the safety mechanism 2. The detent pawl 16 is pre-tensioned, preferably by means of a spring 16a, into the detent position blocking the rotary latch 19 and thus the triggering of the safety mechanism 2. In the illustrated example, the spring is tensioned in a counterclockwise direction.

To prevent unwanted unlocking of the rotary latch and thus unwanted release of the safety mechanism 2, the detent pawl 16 can be blocked in the detent position by a boss or the like (not shown) arranged on the worm wheel 12, if the gear 4 or at least the worm wheel 12 is in the start position, therefore in a position of unwanted actuation. The gear 4 preferably has at least two gear stages, where the reset spring 11 preferably engages between the first and second gear stage or directly on the actuator 3 to ensure secure resetting. With only one gear stage, the reset spring 11 correspondingly engages directly on the actuator 3 or its driven component.

The advantage of resetting in the start position is that the starting position is determined relatively accurately in the event of triggering, so that defined and short actuation or trigger times can be achieved.

In the illustrated example, the worm gear pair 9 forms a first gear stage and the cam/lever combination 10 or the drive element 15 with the detent pawl 16, forms a second gear stage. With two gear stages, the gear reduction ratio of the driven-side gear stage preferably has at least 0.5 times the other gear stage. Additionally, the gear reduction ratio of the driver-side gear stage can also be at least 0.8 times, and more preferably, at least 1.0 times the other gear stage.

As already noted, the actuator 3, if the worm wheel 12 stops on the stop 7, can be switched off preferably depending on the actuator current.

Alternatively or additionally, the actuator 3 can also be switched off time-dependent, in particular after a preset time period has expired. This is particularly meaningful for the case where the function test is performed and the actuator 3 does not work. With such a failure or in another breakdown, a corresponding warning or error message is displayed for the motor vehicle user. The advantage of a microswitch is that it is cost-effective and enables simple control. For example, a Hall sensor provides greater reliability.

In the illustrated example, the sensor device 8 preferably has a microswitch. With the function test, the microswitch can be actuated, for example, by a boss 22 or the like, also positioned on the worm wheel 12. This allows the sensor device 8 to detect when the actuator 3 is working in the function test against the direction of trigger 5 and when the actuator 3 has moved the gear 4 or worm wheel 12 against the direction of trigger 5.

Immediately then, if needed, prior to running the stop 6 onto the stop 7, the actuator 3 can be switched off. Next, via the preferably non-self-locking worm gear pair 9, the worm wheel 12 and also the actuator 3 can be reset by the reset spring 11, back to the start position.

During the function test, the actuator 3 preferably rotates at least one full revolution to ensure uniform brush wear and/or uniform abrasion. In particular, the actuator 3 describes even several revolutions during the function test. The function test is preferably performed regularly and/or automatically, for example, after repeated opening, starting or locking of the motor vehicle, for example, after the 10th or 20th time or the xth time, where x is a predetermined or fixed number. It is especially preferred if the function test is performed as the motor vehicle is being locked. In this case, a motor vehicle user does not notice or hear the function test being run. In particular, the noises caused during the function test are drowned out or smothered by the noises occurring during locking.

The actuator device 1 is preferably assigned a control device 1a or electronics to enable corresponding control and evaluation or verification of the operability and, if needed, also triggering of the safety mechanism 2 in an emergency.

The actuator device 1 is preferably designed such that, after triggering, relocking is possible with moving or turning back the actuator 3, the gear 4, and the worm wheel 12, into the start position. In this way, a relocking is possible in a workshop only, for example, if the moving back is to be done manually.

As already noted, electronic evaluation or acknowledgement is preferably done to determine whether the actuator 3 is operable or not. In particular, detection of the operability during the function test is done by means of the sensor device 8. However, sensor device 8 is not absolutely required. As already mentioned, the operability of the actuator 3 can also be established, for example, by corresponding evaluation of the actuator current.

The non-self-locking design of the gear 4 or at least of the worm gear pair 9 provided in the illustrated example enables the gear 4 or worm gear pair 9 and the actuator 3 to be reset by resilient force, here by the reset spring 11.

With the preferably high gearing down in the second gear stage, on the contour of the drive element 15 acting on the detent pawl 16, it is possible to use a comparatively slight gear reduction in the worm gear pair 9. This is beneficial to improve device efficiency in the direction of trigger 5 and against the direction of trigger 5.

When the gear 4 or the actuator 3 is operated in a block mode, therefore switching on until stop 7 is reached, there is minimal control effort required. The provided short-circuiting of the actuator 3 during reset leads to the start position being reached more precisely. In addition, locking (not shown) of the gear 4 or of the worm wheel 12 can be obtained in the zero or start position, for example by a peripherally engaging detent tooth or the like. This allows obtaining the start position in a snap-in-mode. Thus, the start position is reached more precisely and also maintained, also with vibrations of the motor vehicle.

When the detent pawl 16 is blocked in its detent position by the worm wheel 12 in the start position or by another gear part, the detent pawl spring 16a can be configured to be less strong.

The safety mechanism 2 preferably has a spring actuator 23 which has the safety mechanism 2 activate its safety function after the actuation element 21 is released, and causes the provided displacement of a motor vehicle part 24 for protecting persons located both inside and outside the motor vehicle.

The motor vehicle part 24 is preferably a headrest, padding, a seat, a steering wheel, a safety net, a roll bar, a lock, a bonnet, a valve or a part thereof.

In the preferred embodiment shown in FIG. 2, the above-noted motor vehicle part 24 is a headrest 25, which includes a roll bar 26. FIG. 2 shows this preferred embodiment in a state with the safety mechanism 2 not being triggered. The roll bar 26, which carries the headrest 25, is pre-tensed upwards (in FIG. 2) against a fixed part 27 of the motor vehicle body. The actuator device 1 holds this state due to the engagement of the actuation element 21 with the rotary latch 19 and due to the engagement of the rotary latch 19 with the detent pawl 16. The emergency triggering of the safety mechanism 2 by the actuator device 1 causes the roll bar 26 to quickly move upwards to reach its activated position. It is to be noted that in FIG. 2 the only component of the actuator device 1 illustrated is the rotary latch 19. However, it is to be understood, that the complete actuator device 1 as described above is assigned to the embodiment illustrated in FIG. 2.

1. An actuator device for triggering of a safety mechanism of a motor vehicle comprising:
an actuator and a gear, wherein the actuator is operable in a triggering direction for triggering the safety mechanism and the actuator device has a function test mode in which the actuator is operable for checking its operability without triggering the safety mechanism.

2. The actuator device as claimed in claim 1, wherein the actuator works electrically, and is an electromotor.

3. The actuator device as claimed in claim 1, wherein the actuator is a linear drive or motor.

4. The actuator device as claimed in claim 1, wherein the actuator is controlled electrically.

5. The actuator device as claimed in claim 1, wherein the actuator is operated during the function test, counter to the triggering direction.

6. The actuator device as claimed in claim 1, wherein at least one of the actuator and the gear has a preset play which must be overcome before triggering of the safety mechanism occurs.

7. The actuator device as claimed in claim 1, wherein the actuator is decoupled from the safety mechanism during the function test so that the actuator is operable in the triggering direction.

8. The actuator device as claimed in claim 1, wherein, during the function test, the actuator is run against at least one of a resilient force and a stop.

9. The actuator device as claimed in claim 1, wherein, during the function test, the actuator current is obtained and evaluated to check the operability of the actuator.

10. The actuator device as claimed in claim 1, wherein at least one of the actuator and the gear is reset to a start position by a resilient force, after or during the function test, after the actuator is switched off.

11. The actuator device as claimed in claim 10, wherein the actuator is short-circuited during resetting to the start position, wherein the generator current or short-circuit current of the actuator is obtained and evaluated during resetting for checking the operability of the actuator.

12. The actuator device as claimed in claim 10, wherein the start position is obtained in a snap-in-mode by employment of a peripherally engaging detent.

13. The actuator device as claimed in claim 1, wherein the actuator is operated for at least one full revolution during the function test.

14. The actuator device as claimed in claim 1, further comprising a sensor device for detecting at least one of a position and a motion of at least one of the actuator and the gear.

15. The actuator device as claimed in claim 1, wherein the actuator is operated during the function test, until its operability or reaching of a test position is detected.

16. The actuator device as claimed in claim 15, wherein operability of the actuator or said reaching of a test position is detected by means of a sensor device.

17. The actuator device as claimed in claim 16, wherein the sensor device further comprises:
a microswitch or a Hall sensor.

18. The actuator device as claimed in claim 1, wherein the gear is non-self-locking.

19. The actuator device as claimed in claim 1, wherein the gear has at least one of a worm gear pair and an eccentric/lever combination.

20. The actuator device as claimed in claim 19, wherein the worm gear pair is non-self-locking.

21. The actuator device as claimed in claim 20, wherein the worm gear pair has a speed-reducing ratio of one of 30:1, 25:1, and 20:1 or less.

22. The actuator device as claimed in claim 20, wherein a reset spring is associated with the worm gear.

23. The actuator device as claimed in claim 19, wherein the worm wheel further comprises:
a cam-shaped or spiral-shaped drive element for actuating a detent pawl, wherein the ratio of gear-reduction of the rotational movement of the worm wheel to actuation of the lever or the detent pawl is at least one of 10:1 or 15:1.

24. The actuator device as claimed in claim 18, wherein the worm wheel further comprises:
a boss, which blocks a detent pawl in a detent position blocking the triggering of the safety mechanism, when the gear or at least the worm wheel is in a start position.

25. The actuator device as claimed in claim 1, wherein the actuator device further comprises:
a detent pawl and a rotary latch, for an actuation element of the safety mechanism, wherein the detent pawl, in a detent position, blocks opening or rotating of the rotary latch and with it blocks triggering of the safety mechanism.

26. The actuator device as claimed in claim 25, wherein the detent pawl is actuated and lifted by the actuator by means of the gear.

27. The actuator device as claimed in claim 1, wherein the gear has at least two gear stages.

28. The actuator device as claimed in claim 26, wherein the gear reduction ratio of the driven-side gear stage is at least one of 0.5 times, 0.8 times, and 1.0 times the other gear stage.

29. The actuator device as claimed in claim 1, wherein at least one of the actuator and the gear is operated during at least one of triggering and the function test in both operating directions to against at least one stop.

30. The actuator device as claimed in claim 1, wherein the actuator is adapted to be switched off depending on the actuator current when a stop is reached.

31. The actuator device as claimed in claim 1, wherein the actuator is adapted to be switched off in a time-dependent manner.

32. The actuator device as claimed in claim 1, wherein the function test is performed after a predetermined number of times that the motor vehicle opened, started or locked.

33. The actuator device as claimed in claim 1, wherein the actuator device is a power lock.

34. A safety mechanism having a motor vehicle safety element and an actuator device for triggering movement of said safety element from an inactive position to an active position, wherein the actuator device further comprises:
an actuator; and a gear, wherein the actuator is operable in a triggering direction for triggering of the safety mechanism and wherein the actuator device, in a function test, is operable to check its operability without triggering of the safety mechanism.

35. The safety mechanism as claimed in claim 34, wherein the actuator is operated during the function test counter to the triggering direction.

36. The safety mechanism as claimed in claim 34, wherein at least one of the actuator and the gear has a preset play which must be overcome before triggering of the safety mechanism occurs.

37. The safety mechanism as claimed in claim 34, wherein the actuator is decoupled from the safety mechanism during the function test so that the actuator is run in the triggering direction in the function test.

38. The safety mechanism as claimed in claim 34, wherein the safety mechanism further comprises:
an actuation element which is released from the actuator device during triggering.

39. The safety mechanism as claimed in claim 33 wherein the safety mechanism further comprises:
a spring actuator for displacing a motor vehicle part when triggering the safety mechanism.

40. The safety mechanism as claimed in claim 39, wherein the motor vehicle safety element is at least one of a headrest or a roll bar.

41. The safety mechanism as claimed in claim 34, wherein the safety element and the actuator device form a structural unit.

42. The safety mechanism as claimed in claim 34, wherein the actuator device is attached exchangeably to the safety element.

43. The safety mechanism as claimed in claim 34, wherein the safety mechanism can be triggered only once.

44. The safety mechanism as claimed in claim 34, wherein the safety mechanism can be returned, after triggering, to a newly triggerable state manually by latching or securing the actuation element on the actuator device.

45. A process for checking the operability of an actuator of an actuator device for triggering a safety mechanism of a motor vehicle comprising:
performing a function test wherein the actuator is operated to check its operability without triggering the safety mechanism.

46. The process as claimed in claim 45, wherein the function test is performed at least one of regularly and automatically.

47. The process as claimed in claim 46, wherein the function test is performed after the preset number of times that the motor vehicle is opened, started or locked.

48. The process as claimed in claim 46, wherein the function test is performed during opening, starting or locking of the motor vehicle.

49. The process as claimed in claim 45, wherein the function test is performed only when the motor vehicle is in a standstill condition.

50. The process as claimed in claim 45, wherein, during the function test, the actuator is operated counter to the triggering direction.

51. The process as claimed in claim 45, wherein, during the function test, the actuator is switched on, until at least one of:
actuation or movement of an assigned transmission element is detected,
a preset time period is exceeded,
a corresponding development of current is detected, and
stopping of the transmission element is detected.

52. The process as claimed in claim 45, wherein, in the function test, the operability of the actuator is positively determined, if after the actuator is switched on, at least one of:
actuation or movement of an assigned transmission element is detected,
a corresponding development of current is detected, and
stopping of the transmission element is detected.

53. The process as claimed in claim 45, wherein, during the function test and after the actuator is switched off, at least one of an assigned gear and the actuator is reset to a start position by means of resilient force.

54. The process as claimed in claim 45, wherein at least one of the actuator and an assigned gear is reset to a start position after triggering by means of the actuator for renewed securing or locking triggering.

55. The process as claimed in claim 45, wherein the safety mechanism is triggered once only.
